(19) United States
(12) Patent Application Publication
(10) Pub. No.: US 2026/0104698 A1
(43) Pub. Date: Apr. 16, 2026

(54) MACHINE MONITORING DEVICE AND METHODS FOR HIGH ACCURACY WIRELESS CONTINUOUS MACHINE HEALTH MONITORING AND FAULT DIAGNOSIS

(71) Applicant: KCF TECHNOLOGIES, INC., State College, PA (US)

(72) Inventors: Mattias HOEHNEN, State College, PA (US); Jacob LOVERICH, State College, PA (US); Micah GREGORY, State College, PA (US); Jeremy FRANK, State College, PA (US)

(73) Assignee: KCF TECHNOLOGIES, INC., State College, PA (US)

(21) Appl. No.: 19/360,723

(22) Filed: Oct. 16, 2025

Related U.S. Application Data
(60) Provisional application No. 63/707,943, filed on Oct. 16, 2024.

(51) Int. Cl. G05B 23/02

(52) U.S. Cl. CPC G05B 23/0208

(57) ABSTRACT

A machine monitoring device, method and computer-readable medium are configured for wirelessly monitoring a health condition of a machine. The system includes a low power sensor configured to perform a machine status measurement of the machine at spaced intervals at a low power, a high accuracy sensor configured to selectively perform high accuracy health status measurements of the machine, a processor configured to analyze the machine status measurement to determine whether the machine status measurement is above a trigger threshold, and when the processor determines that the machine status measurement is above the trigger threshold, causing the high accuracy sensor to start high accuracy health status measurements of the machine, and a wireless transceiver to transmit data from the high accuracy health status measurements to a remote server for processing of the data for determining a health status of the machine.

### CROSS REFERENCE TO RELATED APPLICATION

This application claims priority to U.S. Provisional Patent Application No. 63/707,943, filed on Oct. 16, 2024, the disclosure of which is incorporated herein by reference in its entirety.

### TECHNICAL FIELD

This disclosure relates to a machine monitoring device and methods for collecting data for machine health monitoring and fault diagnosis. More particularly, this disclosure relates to such a machine monitoring device and methods for improving the accuracy of wireless machine health monitoring and fault diagnosis using a sampling technique.

### BACKGROUND

Continuous machine health monitoring in industrial manufacturing plants is mainly based on analyzing vibration signatures. This technique has been employed to predict and diagnose machine failures for decades. The machines that are monitored are generally large industrial machines, such as 10-1000 Hp motors, pumps, fans, gearboxes, etc. Conventional technology used to measure vibration has either required a sensor permanently mounted and hardwired into a data acquisition unit or a portable/handheld device, like the Emerson AMS2140, and a magnetically mounted sensor that is moved from machine to machine. The hardwired approach is expensive because cabling needs to be installed and is vulnerable to damage, which drives the solution lifecycle cost. Portable sampling generally involves a reliability engineer walking from machine to machine, which is labor intensive and often dangerous because a person is working around running equipment.

Recent advances in low-cost wireless communication, battery energy density, and cloud computing are enabling both hardwired and portable sampling to be replaced by permanently mounted wireless sensors and cloud-based automated analytics for interpreting the vibration data. The cost effectiveness, ease of use, and wide applicability of wireless machine health monitoring is poised to drive a step change from reactive (performing maintenance when the machine breaks) to predictive (performing maintenance at the most cost-effective time, and typically in advance of failure) maintenance. Predictive maintenance offers clear benefits in terms of reducing loss of production, reducing the cost of the actual repair and safety.

However, wireless sensors have yet to match the accuracy and depth of analysis of portable monitoring tools and the measurement interval of permanent hardwired sensors. These two factors have slowed the adoption of predictive maintenance and limited the scope of applications it can be applied to. For example, a hardwired solution can measure nearly continuously which allows detection and diagnosis of intermittent machine behavior like hard starts and stops, cavitation during process changes, resonance at certain speeds, or overload when the process material is jammed or stuck. Portable or route-based monitoring offers sampling up to 80 kHz with 24 bit amplitude resolution, and 12800 lines of spectral resolution.

This high degree of measurement fidelity enables precise identification of running speed, locating side-bands in a frequency spectrum that are indicative of early stage gear or bearing failures, and separating faults that might be associated with a vane pass frequency and a bearing frequency which are sometimes very close to one another. With low frequency resolution, sometimes the data features combine in the frequency spectrum and are expressed as a single peak. This limits the accuracy of the diagnosis because the one peak can't be used to represent the vane pass nor bearing frequency.

Wireless sensors are not able to match the performance of hardwired or portable systems because they are limited by wireless bandwidth or data throughput and energy storage capacity in the batteries. There are generally three key sensor characteristics that can be traded off when designing a wireless sensor for predictive maintenance 1) fidelity of the monitoring, 2) wireless communication range, and 3) life cycle cost of the sensor. Monitoring fidelity is determined by acquisition rate, sampling frequency, and sample set duration which determines accuracy of the monitoring and directly impacts the amount of energy consumed by the sensor. The wireless communication range similarly directly increases energy usage and limits bandwidth because sensors will interface with more wireless devices as the range of communication is extended. This is compounded by the fact that the wireless communication is the primary energy consumer in the energy budget for these types of sensors. And finally, the lifecycle cost is influenced by many factors but the size of the energy storage (battery) or alternative the battery replacement interval is a dominate driver. The trade-off may involve increasing range at the expense of higher lifecycle cost, or reduced data fidelity. Or measurement fidelity can be increased if wireless range is decreased. Owing to this trade-off most wireless predictive maintenance sensors are used for early warning but not for high accuracy diagnostics which is needed for any application where maintenance costs are high. For example, replacing a medium size motor can cost $10-50 k and many gearboxes that are used in an application with power throughput larger than 100 Hp have long lead times of upwards of 6 months. These maintenance scenarios are common and require advanced diagnostics beyond what typical wireless predictive maintenance sensors can offer that are currently serving the market.

Accordingly, what is needed is a solution that addresses this complex tradeoff between monitoring fidelity, wireless range, and lifecycle cost by increasing measurement fidelity to near levels of portable systems and hardwired solutions without requiring a compromise of wireless range nor increases in lifecycle cost. This is the key to wireless predictive maintenance sensors receiving adoption across a much broader set of applications and industries than what they serve today. A technical approach with an intelligent way to selectively reduce data volume sent over the wireless link without losing key diagnostic content would be advantageous.

Other significant benefits of such intelligent data reduction are lower storage cost whether it be at a local server or in the cloud and reductions in analytical cost to process the data using machine learning algorithms or other automated analytics techniques.

Techniques to reduce data volume such as data compression techniques have successfully been employed in the past to address this quandary like described in U.S. Ser. No. 10/873,791B1. However, such data compression techniques have generally offered a ˜3-8× increase in monitoring performance, while several orders of magnitude increase in performance are needed to match the value delivered by hardwired solutions.

There is also significant existing intellectual property defined around signal processing for enabling advanced analytics as described in U.S. Pat. No. 5,895,857A and US20080033695A1. These methods are useful for manipulating the data to be useful for specific fault types. This patent employes some of these techniques like Envelope analysis but one aspect of innovation lies in how it is selectively applied rather than applying it to every data set.

Other patents disclose improving sensitivity by amplifying certain aspects of a vibration spectrum (U.S. Pat. No. 6,053,047A), or performing digital frequency compensation (U.S. Pat. No. 9,341,512B2), but they are not considering ways to reduce data volume while preserving fidelity. These approaches and many more focus on improving accuracy rather than focusing on measuring the machine more frequently and at the right time, and secondly, optimizing the frequency resolution of the data sets which is foundational to any further analysis.

Intellectual property adjacent to this invention discloses ways of utilizing training algorithms and combining machine health data with operation data to improve analytics (U.S. Ser. No. 11/429,900B1). Some focus on novel magnetic field sensing (US20230080171A1). These patents assume they have sufficient data fidelity to achieve the intended results. What is needed is an approach that ensures high accuracy data is acquired at the right times and in a cost-effective way to be applied to a wide range of machines that would not otherwise benefit from the value of continuous monitoring and predictive maintenance.

### SUMMARY

Embodiments of the invention include a machine monitoring device, method and computer-readable medium configured for wirelessly monitoring a health condition of a machine. The system includes a low power sensor configured to perform a machine status measurement of the machine at spaced intervals at a low power, high accuracy sensor configured to selectively perform high accuracy health status measurements of the machine, a processor configured to analyze the machine status measurement from the low power sensor and to determine whether the machine status measurement is above a trigger threshold, and when the processor determines that the machine status measurement is above the trigger threshold, causing the high accuracy sensor to start the high accuracy health status measurements of the machine on an adjustable sampling interval, where a duration of the adjustable sampling interval is determined based on a level of the machine status measurement relative to one or more interval setting thresholds, and a wireless transceiver configured to transmit data from the high accuracy health status measurements to a remote server for processing of the data for determining a health status of the machine.

Embodiments of the invention may include one or more of four elements that enable a significant improvement in machine health monitoring: 1) asset status monitoring and sensor acquisition control, 2) coordinated sampling of three vibration sensors a temperature sensor and magnetic flux sensor, 3) onboard wireless sensor Envelope analysis, ultrasonic bandpass filtering, and multi-region sampling, filtering, and post processing, and 4) programing the machine status monitoring and acquisition control program in the cloud or local server based on historical data and then sending it back to the node to execute. Embodiments of the invention may be configured to cause the sensor node to capture rapidly changing machine behavior with very high accuracy/rich data sets while using the smallest possible amount of energy to enable long battery life and a low congestion wireless communication environment.

Embodiments of the invention may include a machine status monitoring program that is configured to be programed in the cloud based on historical data, such as past measurements, but is implemented using simple rules or algorithms on the sensor node. The program may be configured to detect rapid changes in machine behavior or operating conditions to initiate high accuracy data to be captured during important short duration events. This method enables a low power sensor to replicate the capability of hardwired solutions that continuously monitor machines using much lower energy. In the simplest form, asset health status monitoring may include taking a machine status measurement of a condition or conditions of a machine using a low power sensor, and determining from the measurement whether a high accuracy measurement triggering condition of the machine has occurred. The machine status measurement may be taken on a regular basis. If the high accuracy measurement triggering condition is determined to not have occurred, the low power sensor continues to take the machine status measurement. If the high accuracy measurement triggering condition is determined to have occurred, then a high accuracy sensor is controlled to perform high accuracy machine health conditions to be made.

The machine status measurement may be an RMS velocity or acceleration measurement or another type of measurement indicative of conditions of the machine needing high accuracy monitoring. In various embodiments, the machine status measurement may be compared to a threshold. Measurement levels above the threshold initiate collection of high accuracy data with the high accuracy sensor. In various embodiments, the high accuracy sensor may be configured to measure data blocks at regular intervals, such as every 1 minute, although other intervals may be used. When the measurement levels are below the threshold, the low power sensor may continue to conduct measurements with the low power sensor, which could be measured at regular intervals, such as every 10 minutes, although other intervals could be used.

In this simplified example, the threshold may be dynamically determined and may be configured in the cloud or remote server on an ongoing basis using historical measurement data such as vibration data, fault cases, machine maintenance history, machine type, etc.

In various embodiments, three vibration sensors may be used to perform the monitoring because there is a tradeoff between sensor power consumption and accuracy. For example, the low power sensor may be a first low power MEMS sensor (such as used in cell phones) that is sufficiently accurate to identify whether or not an machine is on or off, loaded or unloaded, at high speed or low speed, but is not accurate enough for diagnosing many early stage or complex faults that machines experience. The low power and low fidelity sensor may be configured to only sample at regular intervals, such as 200 Hz and use may use RMS or Peak vibration amplitude to determine the machine status. The low power sensor may be a sensor that operates with a low power consumption cost such as in micro amps. Whereas, a higher accuracy sensor may be utilized as the low power sensor, and may be a sensor such as an accelerometer that may consume hundreds or thousands of micro amps alone and require a microprocessor to be powered on to evaluate the readings from the accelerometer to determine the machine state.

A second high power, higher accuracy sensor such as a vibration sensor may be selectively sampled on an interval that is configurable based on execution of the machine status monitoring program. This high accuracy or high accuracy data set is only taken when triggered by the machine status measurement and is what is sent to the cloud or local server and is used for both configuring the machine status monitoring program and for machine fault diagnostics. The high accuracy sensor(s) may utilize a higher power than the low power sensor. For example, the high-power sensors may utilize anywhere from 0.520 mA for the ADXL382 amps to 22 mA for the ADCMXL1021 parts.

A set of complimentary temperature and magnetic flux measurements may also be acquired when the high accuracy vibration data sets are acquired because they are also used for machine diagnostics. Finally, an ultrasonic vibration sensor may be sampled on an interval that is the same or less than the high accuracy vibration data interval. The ultrasonic sensor interval is also controlled by the machine status monitoring program that is run on the sensor node. The ultrasonic vibration sensor uses a resonating transducer element tuned to the high frequencies to detect lubrication, air leaks, arch flash, and early-stage gear or bearing failures. A single piezoelectric accelerometer could be designed to perform the tasks of all three vibration sensors, but its constituent performances would be compromised relative to such a three-sensor design and its cost would be higher than that of the three accelerometers. In particular, it would consume more energy, require additional electronics for the second, and have lower sensitivity for several key areas of the frequency spectrum.

Envelope analysis is either selectively applied at the wireless sensor node on an interval determined by the machine status program or when the level of high frequency energy in the vibration spectrum is high. This selective use of Envelope analysis makes it practical to apply on a wireless sensor without dramatically increasing the energy budget of the sensor. The ultrasonic vibration sensor is high accuracy similarly acquired on an interval that may or may not be synchronous with the high accuracy vibration sensor. The ultrasonic vibration measurement may be bandpass filtered using, for example, a 35-40 kHz filter. The Peak and RMS values in the band pass filtered data is recorded and sent over the wireless link rather than the full timeseries data sets.

A multi-region data processing step is applied to the high accuracy vibration data. It involves selectively thinning (or decimating) the data to reduce the data payload that is sent over the wireless link. The selective thinning preserves the high spectral resolution and high frequency content by only removing certain data points at certain points during the time block. The result is the data set contains several regions or periods of time with different sampling frequencies. Upon the data being sent to the cloud or local server, the data is broken into separate raw time series data sets, transformed into the frequency domain. It can then be combined into a single multi-region frequency spectrum or kept as separate spectrum and time waveforms. The spectrum offers fine spectral frequency resolution where it is needed to separate faults that have minor differences in how they are expressed. It also contains high frequency spectral data that has less spectrual resolution which allows for diagnosing certain fault conditions that are only exhibited at high frequency. This enables the data payload sent over the wireless link to be low, but the resulting fidelity of the data that can be analyzed in the cloud or local server to be exceptionally high for a wireless solution.

The machine status monitoring and acquisition control program that is executed in the sensor node (machine monitoring device) uses relatively simple analysis of the last few data sets acquired. However, arriving at the optimal analysis that keeps that data volume low while not missing critical fast changing events that the machine may encounter is not trivial. Developing the logic or analytics to perform that analysis is typically formulated or trained in the cloud or local server based on historical data, machine type, fault and maintenance history, and how it is operated. Machine learning and other AI tools maybe used to train the control program.

The program is updated in the cloud on an ongoing basis using the data that is acquired at the node and sent to the cloud. The program is periodically sent back to the sensor node to execute. The updating of the program at the sensor node may be initiated based on the degree of deviation between the current model and the previous one. This assessment may be done in the cloud to minimize wirelessly sending the program to the node.

### BRIEF DESCRIPTION OF THE DRAWINGS

Generally, like reference numerals in the various figures are utilized to designate like components.

FIG. 1 illustrates a typical industrial plant and machine where the machine health monitoring is used

FIG. 2 illustrates a wireless sensor node used for machine health monitoring.

FIG. 3 illustrates a high-level overview of the sequence of steps which are broken into several stages used to monitor the health of machines.

FIG. 4 illustrates the logical flow diagram for executing the machine status monitoring and data acquisition control program.

FIG. 5 illustrates the sequencing of the three different types of vibration data, short duration status check, high accuracy and long data set, and Enveloped data.

FIG. 6 illustrates a progressive decimation or down sampling filter used for generating the multi-region data set, ultrasonic filter for triggering Envelope analysis, and an example Envelope filter.

FIG. 7 illustrates separation of the multi-region data into uniform spaced data blocks and the Fourier transform applied to the separate data blocks, each with uniform data point spacing.

FIG. 8 illustrates how the frequency spectrum data sets may be compiled in a single frequency spectrum with multiple regions of different spectral resolution.

FIG. 9 illustrates the steps of filling in lower resolution portions of the frequency spectrum and taking the inverse Fourier transform to attain a single composite time waveform data set.

FIG. 10 illustrates a comparison of multi-region monitoring as compared to conventional single/fixed frequency sampling.

FIG. 11 illustrates the comparison of the multi-region frequency spectrum relative to fixed spacing between data points in the vibration data blocks for a large roller bearing in a paper mill.

FIG. 12 illustrates a comparison of acquiring the high accuracy data block on a fixed interval versus on an interval determined by the machine status monitoring and data acquisition control program for a paper mill turbine gearbox.

FIG. 13 illustrates a comparison of acquiring the high accuracy data block on a fixed interval versus on an interval determined by the machine status monitoring and data acquisition control program for an RTO fan in a tire manufacturing plant.

### DETAILED DESCRIPTION

Machine health analysis uses small changes in the mechanical motion (vibration) of machines that occur periodically and at high frequency to determine degradation in a component or multiple components and the severity of the degradation. Because much of the information needed for health assessment is at very high vibration frequency, data is acquired in short duration snap shots to minimize the total data collected and analyzed. Even for a system that is not energy constrained (like hardwired monitoring systems), data is collected in blocks so that operations like a Fourier transform can be applied and frequency spectrum analysis conducted. For example, a monitoring system may acquire vibration data at 4 kHz for a period of 1 second.

Embodiments of the invention provide a new framework for selectively capturing data blocks only when they are needed, capturing data within the blocks that has an optimal frequency and duration, and processing the data selectively and deliberately on the sensor and at a local server or cloud. This combination of logic and analytics enables wireless sensors to achieve the responsiveness of hardwired systems and the analytic fidelity of portable monitoring systems without compromising the lifecycle cost of the sensor in terms of battery cost and life nor the wireless communication range. This innovation constitutes a step change toward enabling pervasive predictive maintenance.

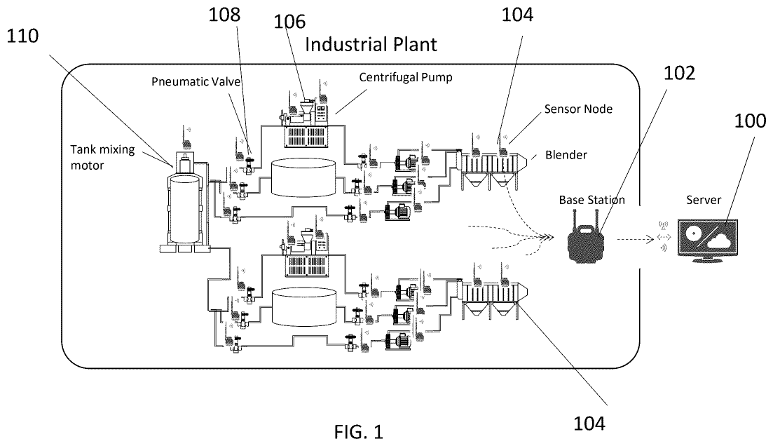

FIG. 1. Illustrates an exemplary environment where the predictive maintenance sensors may be deployed and the wireless architecture that may be used. The machine monitoring device or sensor node 104 may be roughly the size of a golf ball and may be battery powered, with batteries typically lasting 3-5 years. The sensors may be mounted directly on equipment and may be configured to communicate to gateways or base-stations 102 that may also be located within the plant. The gateways may send data over ethernet, WiFi, or other industrial protocol to a local server 100 or cloud where the data is stored, processed and served to a user interface. Owing to the benefits in lowering data storage cost, embodiments disclosed herein may apply more generally to other types of high accuracy sensors, including hardwired sensors, that measure the health of machines in a manufacturing environment. For example, the sensor 104 may be applied to equipment such as the centrifugal pump 106, centrifugal pumps 108, tank mixing motor 110, or any other type of equipment being monitored.

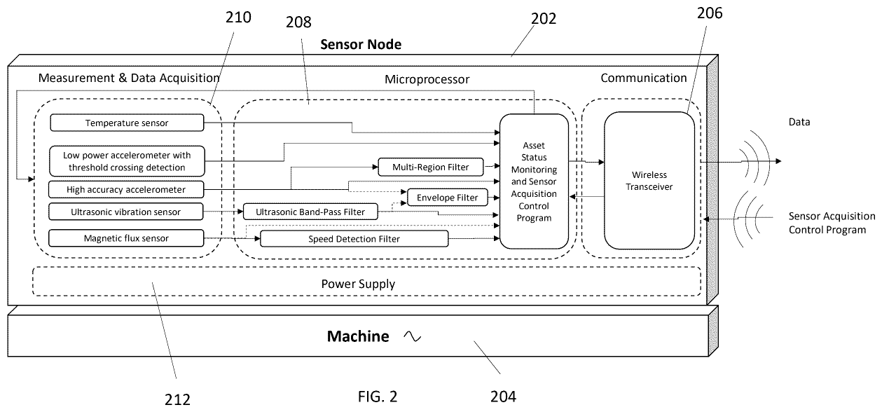

FIG. 2 shows a typical wireless machine monitoring device (sensor node) 202 that may be used in accordance with various embodiments. The sensor node 202 may be positioned near or on a machine 204 to be monitored. The wireless sensor node 202 may include a transceiver 206 for wireless communication, one or more transducers 210 which may include one or more accelerometers, temperature sensors, humidity sensors, magnetic flux density sensors or other types of sensors, a microprocessor 208, and a power supply 212. The transceiver 206 may be configured to send and receive wireless communication signals. The transceiver 206 may be connected to the microprocessor 208 and the microprocessor 208 may be configured to send and receive signals to and from the microprocessor 208. Additionally, the microprocessor 208 may be configured to perform many tasks, which may include running of various programs in accordance with various embodiments. The sensor node 202 will also include a memory (not shown) for storing data and programs to be run by the microprocessor. The memory may be a part of the microprocessor 208 or separate therefrom. The microprocessor 208 is also connected to the transducers 210, and is configured to control the transducers 210 in accordance with programs run by the microprocessor 208. One or a plurality of microprocessors could be utilized in accordance with various embodiments.

The temperature sensors may typically be embedded in the MEMs accelerometer or the microprocessor or a separate transducer in the sensor node 202. The temperature sensors typically can operate in a very low power state and can take measurements frequently with little impact on the sensor total energy budget. A low power sensor, typically a MEMS accelerometer, offers rapid turn-on and settling time and low current draw while measuring. It may include built in vibration level triggering which allows the main node microprocessor 208 and the wireless transceiver 206 to remain in a sleep state until the accelerometer recognizes that the machine is on (vibrating) and wakes the node. This conserves energy because the sensor node 202 may be configured to acquire high accuracy data sets infrequently or not at all when the machine 204 is off. An example is a pump in an oil or gas tank farm. The pumps are only run when emptying or filling the tanks and therefore remain off for long periods of time. The triggering can also be used for waking the node when transitioning between different speeds, operating state, or loads.

A second high accuracy sensor is used to acquire the key vibration data that is used to identify fault conditions and diagnose the machine problems. The higher accuracy sensor could be a piezoelectric or MEMS accelerometer. High accuracy refers to properties of the sensor that include a low noise floor, wide spectral bandwidth, and flexibility to filter or process the data. For example, Hansford HS-004-100 accelerometers may be used, which typically may have a settling time of 1 second (this is very long), but a noise floor of only 20 μG/√Hz rms. Alternatively the ADXL326 accelerometers could be used which may have a settling time of 1 ms and a noise floor or 300 μG/√Hz rms. These higher accuracy sensors are used selectively based on the status of the machine as determined by the machine status monitoring and control program in accordance with various embodiments.

The sensor node may also include a third ultrasonic vibration transducer. This sensor is typically designed to measure acoustics or vibration in the 20-40 kHz range. Machine vibration is very low (often mG or μG) in the ultrasonic range and therefore it is common to use a resonance frequency in the transducer to amplify the mechanical vibration, thereby increasing the sensitivity of the transducer.

The sensor node 202 may also include a magnetic flux density sensor such as a Hall effect sensor or a wire coil that measures the stray magnetic flux density radiating from certain machines like induction motors. The magnetic flux density sensor may be used to determine the electrical line frequency, particularly for variable speed machines like motors powered by a VFD.

The sensor node 202 may include a data acquisition stage where signals from the sensors are conditioned and filtered and an ADC. The filters may include a low pass antialiasing filter or vibration or a band pass filter for speed measurement. However, many MEMS transducers have built in ADC and antialiasing filtering which is optimized to the transducer.

The sensor node 202 may include the microprocessor 208 as the central processor for executing the machine status monitoring and control program, data processing, and operating the wireless transceiver. The microprocessor 208 also performs signal processing like Envelope analysis, ultrasonic RMS and Peak computation, and the multi-region data processing. The microprocess 208 will need to perform this processing while data is collected to avoid requiring very large data storage and post processing.

In accordance with various embodiments, the microprocessor 208 may be included in a single-chip embodiment which includes the wireless transceiver 206. In this case, the wireless transceiver 206 would not be a separate unit as shown in FIG. 2.

The wireless transceiver 206 of the sensor node 202 may communicate bidirectionally with a gateway or base-station. Generally, data is sent from the sensor node 202 to the gateway and commands are sent from the gateway to the sensor node 202. A power supply 212 may include an energy harvester, battery, or hardwired power from a PLC or other device. In some embodiments, the wireless transceiver 206 and the microprocessor 208 may be combined in a single chip.

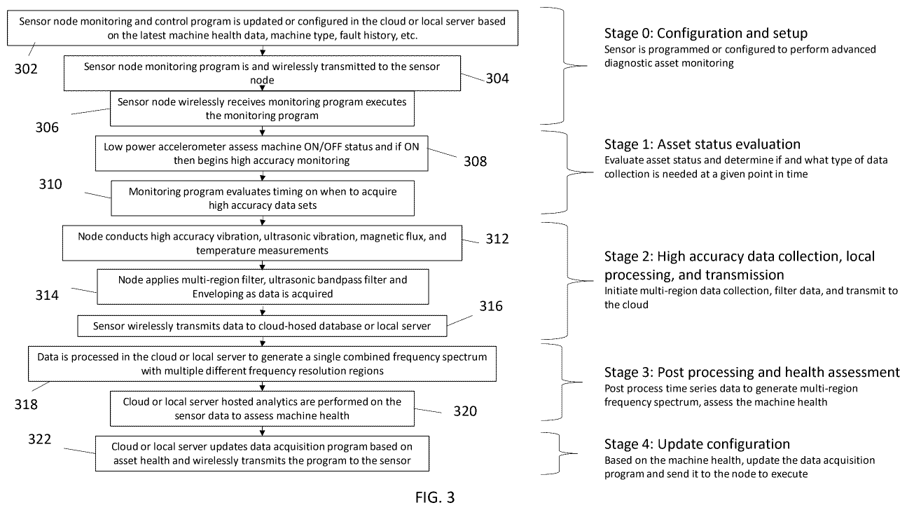

FIG. 3 Shows the overall operation sequence of the sensor node 202. Stage 0 including steps 302, 304 and 306 is a setup stage where aspects of the machine 204 are input. Various aspects may be used, such as the expected running speed, location of the sensor 202 on the machine 204 (Ex: motor vs gearbox), fault or maintenance history of the machine, current and historical health status of the machine, and other factors are used to configure or train the machine status monitoring and control program. Machine learning can be used to tune, for example, the relationship between the signal acquisition interval and a level of the last few vibration data sets acquired. The machine status monitoring and control program is configured to control sampling, which may involve applying the low power sensor sampling based on a trigger threshold, adjusting intervals for acquiring high accuracy data sets including Enveloped data, multi-region data, ultrasonic data, temperature, and magnetic flux data. Upon configuration, updates to the program relative to the last program are adopted. If a significant deviation exists, then the sensor program is sent from the cloud or local server to the sensor node and the node switches to using the new variant of the program.

A basic implementation of the program that may be used in accordance with various embodiments includes a set of rules that use a trigger threshold. The trigger threshold is used to evaluate the machine status and controls when the node 202 enters and exits a sleep mode where in the sleep mode all high accuracy data acquisition by the sensors is suspended under control of the microprocessor. A separate sampling interval setting threshold is used to adjust the high accuracy data collection interval or how frequently diagnostic data sets are acquired. When the machine status measurement is above the interval setting threshold, the acquisition interval is accelerated. For example, when the machine status measurement is between the trigger threshold and the interval setting threshold, the acquisition interval could be every 60 minutes but when it is above the interval setting threshold, the acquisition interval could be 20 minutes.

There may be many interval setting thresholds and many corresponding acquisition intervals that can be set according to various embodiments. Similarly, there could be a continuum where a function maps the acquisition interval to the machine status measurement level. Interval setting threshold can be a fixed value or computed in the sensor based on prior values.

The machine status can be acquired by the low power sensor or from one or more of the high accuracy sensor measurements.

One example for how the trigger threshold is determined may use statistical features (e.g., RMS or peak acceleration) from a 30-day buffer to dynamically calculate a threshold that separates operational (“ON”) and inactive (“OFF”) states. This threshold may be periodically updated in the cloud and transmitted to the sensor to suppress data transmission during idle periods of the machine in accordance with various embodiments.

One example for how the interval setting thresholds are determined may analyze 30 days of vibration data to compute an upper control limit or similar statistical threshold that defines the boundary of normal equipment behavior.

Rules can be applied to set the acquisition interval based on a group of machine status measurements relative to interval setting threshold. Several example rules for applying the interval setting threshold at the node may be the following:
a. Rule 1: If the most recent status measurement exceeds the interval setting threshold, set the sampling interval to 60 seconds.
b. Rule 2: If 4 out of the last 5 status measurements exceed the mean plus one standard deviation, set the interval to 10 minutes.

During Stage 1 including steps 308 and 310 the sensor node 202 may conduct routine machine vibration status checks at a frequent basis (e.g., 200 Hz). These checks serve two purposes, near-real-time visibility into the health status of the machine and secondly trigger a high accuracy monitoring mode when the machine is ON. For example, the health check may use the low power, low fidelity accelerometer. The RMS vibration level or several points taken at 200 Hz can be compared to a threshold like 0.1G. If the vibration is above the threshold, the machine is considered ON. Because the data is low fidelity, it is only sufficient for basic monitoring and is not used for machine fault diagnostics. When the machine is considered to be ON, this is used by the program to evaluate timing on when to acquire high accuracy data sets in 310.

In certain embodiments, the low power and high accuracy sensors can be the same part. For example, a short duration sample can be acquired as a status check, and then a longer duration sample can be acquired selectively using the same sensor.

Stage 2 including steps 312, 314 and 316 is initiated on a reoccurring basis or at an interval defined by the machine status monitoring and control program. During this stage, longer duration (hundreds of milliseconds to dozens of seconds) sampling may be conducted using a high accuracy accelerometer for example. Ultrasonic vibration data, magnetic flux data, and temperature data are also acquired. The ultrasonic data may be acquired from a separate dedicated sensor that is optimized for measuring at very high frequencies.

The raw data is processed in 314 at the node in several ways producing a multi-region data set, ultrasonic assessment, and Enveloped data set. The processing mainly consists of data filtering including bandpass, decimation, RMS averages, and peak hold. Only the minimum necessary data for accurate and comprehensive analysis of the machine's health is sent wirelessly to the cloud or local server, thereby maximizing the battery life at the node. In 316, the sensor node is configured to transmit the data to the database or local server.

Stage 3 including steps 318 and 320 involves processing the multi-region data set and performing advanced spectral analysis. In some embodiments, this analysis may be performed in the cloud or at a local server. The multi-region analysis is a significant aspect of the embodiments disclosed herein. It enables highly complex and high-resolution analysis to be completed using relatively small data sets. In other words, this format for the data contains high concentrations of key information and no extraneous information. The advanced spectral analysis may include various other capabilities including machine learning and AI. These capabilities but are enabled by the high accuracy data provided by this innovation. In 320, cloud or local server hosted analytics are performed on the sensor data to assess machine health.

During Stage 4 including step 322 the machine status monitoring and control program is updated. The program is revised in the cloud or local server and then sent down to the sensor node to execute. In the simplest embodiments, the program consists of applying rules that use amplitude thresholds. The rules dictate the high accuracy data collection interval. A second or third set of rules and thresholds can be used to selectively initiate or update the Envelope data filtering or the ultrasonic data collection intervals. The program also determines the sampling rates for the multi-region data acquisition, whether or not speed should be monitored, and if ultrasonic and Envelope analysis should be applied. For example, a sensor on a motor will require speed monitoring and ultrasonic monitoring but a sensor on a fan support bearing or gearbox will not require speed monitoring because there will not be a magnetic field present to monitor. Similarly, sampling rates will depend on the location of the sensor and the particular machine. If a pump running at 3600 rpm is monitored vs one running at 1800 rpm, the multi-region sampling frequencies will be lower for the 1800 rpm machine than the 3600 rpm machine. The machine status monitoring and control program is transmitted over the wireless link via a gateway or base station and ultimately to the sensor node.

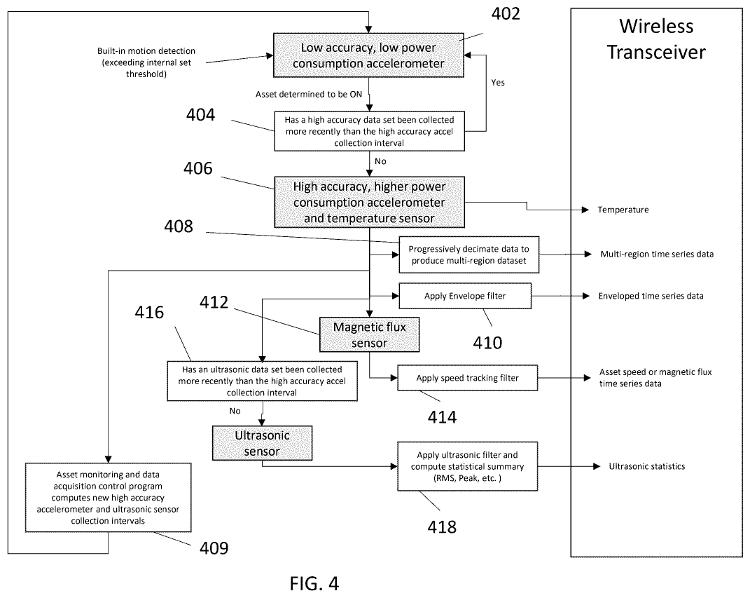

FIG. 4 shows an outline of the sequence of steps for monitoring machines. In 402, the monitoring is initiated by the low power sensor. The sensor determines what state the machine is in (typically ON/OFF). The sensor data (typically vibration data) acquired from a low power sensor may only have a duration of several milli-seconds, just enough to capture several dozen cycles of the shaft rotation of the machine. This data set is then processed to generate several key indicators like RMS velocity and peak acceleration. The indicator levels can then be compared to a threshold level to determine if the machine is in a state where diagnostic data sets should be acquired. The threshold levels can be generated in several ways including using historical statistical data acquired from the machine or based on a fixed level based on that specific machine type.

When the monitoring program determines that the machine is ON (or warrants high accuracy monitoring) in 402, the node immediately acquires a high accuracy data set, so long as a high accuracy data set has not been taken in an immediately prior time period that is less than the interval that is set by the monitoring program. If the machine is already ON, and the time period since the last high accuracy data set was acquired exceeds the trigger interval, then a high accuracy data set is acquired. This selective sampling of data blocks can be referred to as “SmartSampling”.

The high accuracy data may be acquired in 406 from three axes of vibration (X, Y, Z). The Z axis is often perpendicular to the machine surface and X and Y are normal to each other and parallel to the surface that the sensor is mounted to. On a motor the Z axis might be measuring vertical radial vibration, X axis might be measuring horizonal radial vibration, and Y axis measuring axial vibration. The high accuracy acquisition or Envelope analysis may only be completed for a single axis or all three depending on the machine. Similarly, low power accelerometer measurement may only be completed on one axis of data or three depending on the specific sampling configuration.

Typically, a temperature sensor will be embedded with the high accuracy sensor and will be measured along with the high accuracy sensor data because there is a temperature sensor often embedded with the high accuracy sensor (like an accelerometer) which is used for sensitivity and offset temperature compensation.

The high accuracy data may be processed in several ways prior to sending to the cloud or local server. The processing may include progressive decimation of the data in 408 into a multi-region data set that contains partially overlapping but distinct sampling frequencies. It also may include performing a high frequency band pass operation on the raw time series data to extract an RMS and peak value. Envelope filtering in 410 or analysis may be applied to a part or all the high accuracy accelerometer data prior to sending to the wireless transceiver. In 409, the asset monitoring and data acquisition control program computes new high accuracy accelerometer and ultrasonic sensor collection intervals for use by the sensor node. The magnetic flux data is collected in 412 from a separate transducer in the sensor node. It is used for both electrical diagnostics and for determining machine speed therefor it is generally measured at the proximal time of the acceleration measurement because the speed will be used in diagnostic assessments performed on the vibration data. For example, speed can be found based on tracking in 414 the electrical line frequency shown in the magnetic flux density spectrum and then searching for the dominant peak in the vibration spectrum that would fall within the maximum motor slip frequency range:

$$E L F / [ P C / 2 ] \times ( 1 - MS ) < RPM < ELF / [ PC / 2 ]$$

In this equation, ELF is the electrical line frequency which is typically 50 or 60 Hz for a fixed speed motor or significantly for a variable speed motor. PC is the pole count of the motor which is typically 2, 4, or 6 and MS is the maximum motor slip that can be expected. The maximum motor slip is typically 5% for a medium size motor. The magnetic flux density spectrum is often very clean with on sharp peak at the line frequency. This peak can be found deterministically with little ambiguity. However, it is not the actual rotating speed of the motor. Rather, it's the rotating speed plus the motor slip frequency which is determined by the load or torque on the motor. At times when the high accuracy data set is acquired, this is a useful technique because there is enough frequency resolution to precisely find speed in the vibration spectrum using the slip band estimation.

Motor current and torque are proportional and motor torque and slip are also approximately proportional during normal operating states. Normal operation is when the current is within a standard operating range. This excludes both startup and shutdown time periods. Similarly, the magnitude of magnetic flux density is approximately proportional to motor current. However, a challenge is that magnetic flux density highly depends on the specific placement of the sensor.

This can be overcome by simply developing a relationship between slip and the magnitude of magnetic flux density at times when high accuracy vibration sets are taken, and speed is found with certainty. This relationship can then be applied for times when the health checks are conducted and high accuracy data is not available.

An example relationship between measured flux density and running speed that would be found by analyzing the high accuracy data is as follows:

| | | Magnetic flux | | |
|---|---|---|---|---|
| | | density frequency | Running | |
| | | of maximum peak | speed found | Slip |
| | Magnetic | found in spectrum | in high | (difference |
| High | flux den- | (electrical line | resolution | between actual |
| accuracy | sity peak | frequency in case | vibration | speed and |
| data set | magnitude | of 2 pole motor) | spectrum | flux peak) |
| 1 | 3.4 mT | 50 Hz | 48.2 | 1.8 Hz |
| 2 | 4.6 mT | 50 Hz | 47.9 | 2.1 Hz |
| 3 | 2.8 mT | 50 Hz | 58.8 | 1.2 Hz |
| . . . | . . . | . . . | . . . | . . . |

The following simple linear regression can be used to create a relationship between magnetic flux density and slip.

$$S = A + FD \times B$$

Where S is the slip, FD is the magnitude of the measured flux density, and A and B are constants found through regression analysis. Determining this relationship can be done in the cloud or local server because precise speed doesn't need to be determined in near real-time on the sensor. It can be determined prior to displaying data in the user interface.

Finding motor speed can be further enhanced by analyzing a high-resolution vibration spectrum, which is often very complex and has multiple peaks that could represent the rotating speed. By using the electrical line frequency and an estimate for the slip, the peak that accurately represents the rotating speed can be accurately found by searching in a narrow frequency band where the rotating speed is expected. Finding the precise rotating speed of the machine is important because it determines where bearing frequencies will be expected in the vibration frequency spectrum and many other key diagnostics vibration features.

In 416, it is determined whether an ultrasonic data set has been collected more recently than the high accuracy acceleration collection interval. If not, in 418 measurements from an ultrasonic sensor can be applied to an ultrasonic filter and to be used in computing a statistical summary (RMS, Peak, etc.) which is transmitted by the transceiver.

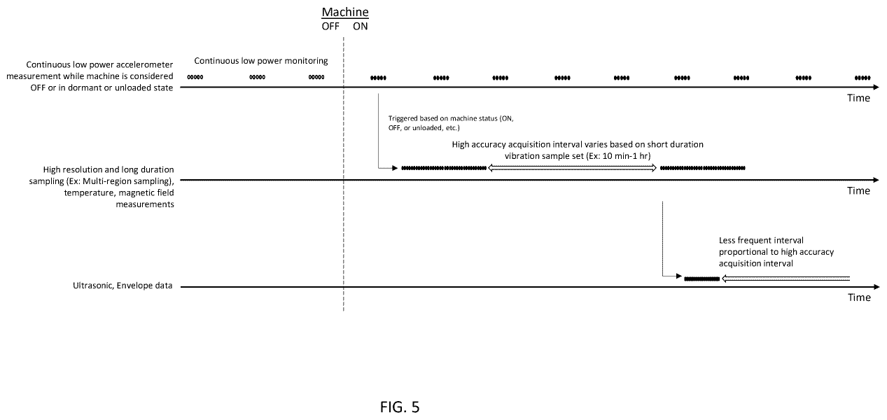

In FIG. 5 a schematic shows the timing and relationship between three different data sets that may be acquired according to various embodiments. As shown, low power status checks such as low power accelerometer measurements are frequent small data sets, high accuracy data sets are acquired only as needed but no less frequently than a preset interval (such as 1 hrs.), and ultrasonic and Envelope data may be acquired even less frequently and only when its warranted or based on high levels of ultrasonic energy.

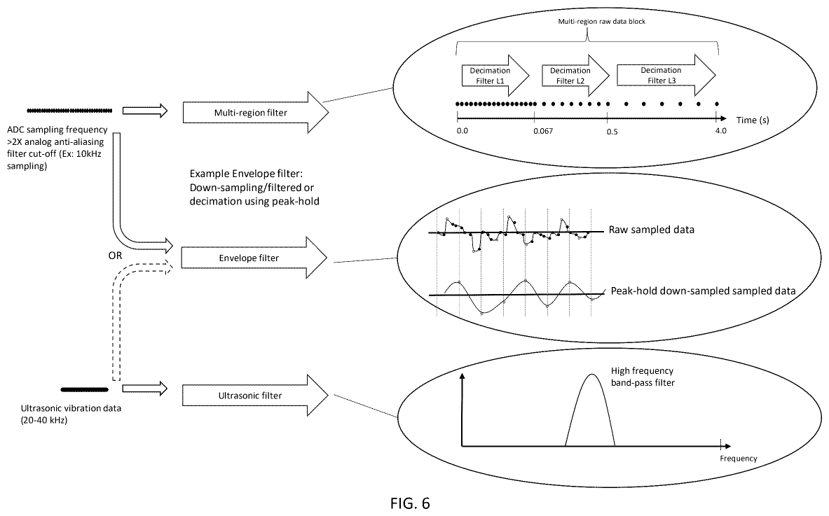

FIG. 6 shows how the high accuracy data may be processed according to various embodiments. The first sequence in the processing is reducing the raw data set to the multi-region time series. The processing thins the data so that only data essential to analysis is transmitted wirelessly. The thinning can be performed many ways including using simple decimation filters and other low pass filtering techniques. Generally, three regions of different sampling frequency and duration allow for a balance between added complexity and level of data reduction. However, two or many more regions can also be used.

Envelope filtering or analysis may be performed on either the ultrasonic data or the high accuracy vibration data. It identifies intermittent impacting and several other phenomena to be exposed in a frequency spectrum or time waveform. Typically, such impacting is hidden in the frequency spectrum because the impacting is expressed in the waveform as a short duration amplitude spike and subsequent ringing, followed by a long period with no similar behavior. The frequency spectrum shows such impacting as a small rise in the noise floor in the frequency range of the ringing. Envelope analysis isolates the impacts and amplifies and translates them down to the frequency corresponding to the time spacing of the impacts. This type of analysis is helpful for identifying impacts associated with a roller in a bearing passing over a crack. Envelope analysis is a common analysis technique and embodiments herein only considers how it is applied with respect to the multi-region data set, and the ultrasonic analysis.

Regardless of which data the Envelop filter uses, the ultrasonic vibration data is passed through a bandpass filter and which is generally located in the ultrasonic range (20-40 kHz). Statistics characterizing the bandpass data like RMS, Peak, Kurtosis, Crest factor, etc. are computed and are sent over the wireless link. Ultrasonic measurements are useful for low-speed equipment which require long sample durations to capture many cycles of rotation. The combination of long duration and high sampling frequency necessitate sending statistical summaries of the ultrasonics signal rather than raw data over the wireless link because of the combination of long duration and high sampling frequency.

The ultrasonic measurement can be used to indicate early bearing damage, lubrication issues, or other issues like cavitation. Generally, early stage bearing failures will create small impacts that cause the bearing to resonance at is natural frequencies. These frequencies vary depending on the bearing but generally are in the 20-40 kHz range. Similarly, lubrication issues are expressed in a similar way because the rolling elements are making metal on metal contact rather than hovering on a film of grease or oil. The imperfections in the metal surface create high frequency noise as the rolling elements move. When the ultrasonic signal is modulated by the rotation, then the fault is likely an early stage bearing issues vs lubrication issues which are more continuous in nature.

Upon performing the multi-region data thinning and ultrasonic assessment, Envelope filtering, and speed assessment, all four data sets are sent to the cloud or local server for trending and diagnostic analysis. The next series of processing steps pertain specifically to the high accuracy multi-region data sets that are sent to the cloud or local server. The processing steps are performed in the cloud or local server, not the sensor. A common approach to vibration spectral analysis uses equal spacing of “lines” in the frequency spectrum. The equal spacing is convenient but not necessary to perform high accuracy machine health diagnostics and further it often results in excessive density of lines in the higher frequency regions and not sufficient in the lower regions.

By using the multi-region technique, data can be limited to only the minimum required resolution for each of several ranges of the frequency spectrum. This results in a much lower volume of data that is acquired, processed, wirelessly transmitted, analyzed, and stored. This approach both enables the high accuracy monitoring capability of portable and hardwired monitoring solutions in a wireless solution but also optimizes the total cost of deploying a system by minimizing cloud storage, and automated analytics cost like machine learning.

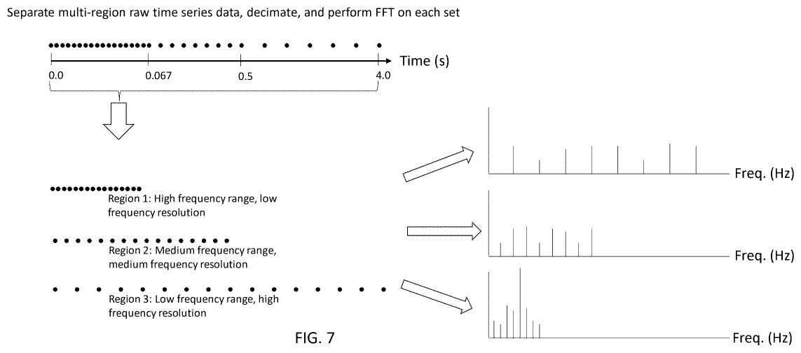

FIG. 7 shows how the raw data from the multi-region data set (three different sampling frequencies in one data set) is broken into multiple (typically 3) separate data sets having equal frequency spacing. Equal spacing is required to apply a Fourier transform using algorithms like an FFT. To separate the raw multi-region data into data sets having uniform point spacing or sampling frequency, the highest frequency data is first extracted which constitutes Region 1. Region 2 is the next highest frequency data or second highest density of points. This data set needs to use both data within Region 1 and also the next lower density data so the maximum frequency resolution in the frequency domain can be attained. To use Region 1 data for Region 2, it is decimated using the same or similar technique shown in FIG. 6.

The overlap of the three regions in the raw data is intentional and is a key aspect of minimizing the data payload sent over the wireless link. Various embodiments focus on 3 regions, but other embodiments could have 2, 3, or more different sampling frequencies or regions. The separate equally spaced time series data are translated to the frequency domain using a transform such as an FFT. Separate frequency spectrum are generated for each of the Regions.

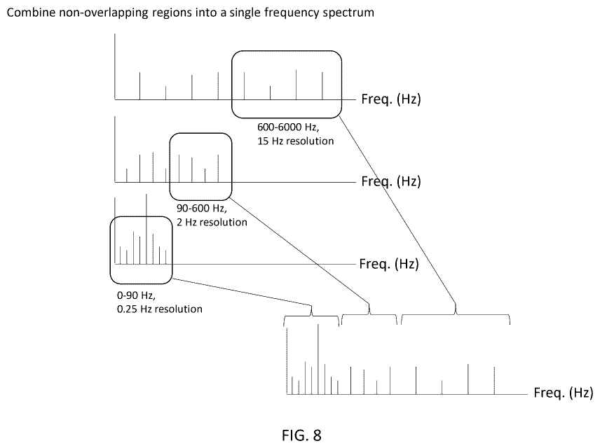

FIG. 8 shows the frequency spectrum stacked together into a single spectrum. This single spectrum contains multiple (three in this case) different regions that have different densities of frequency resolution. The low frequency region has the highest density, and the high frequency region has the lowest density.

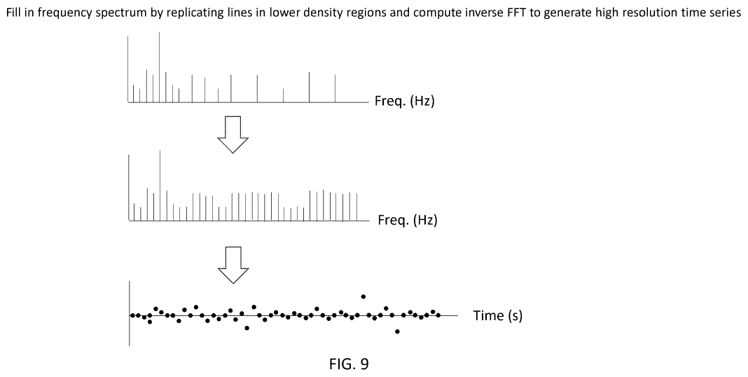

As shown in FIG. 9, a final step may include filling in portions of the frequency spectrum where the spectrum has a lower density (Region 2 and 3) in accordance with various embodiments. This can be achieved by averaging nearby lines of resolution adjacent to gaps and adding them into the gaps. With the fully populated frequency spectrum of uniform spacing, a new time waveform can be generated by applying an inverse FFT.

The sampling rate and duration for each region may be determined by the way in which a particular part of the frequency spectrum is to be used. For example, the low frequency portion of the frequency spectrum may be used for resolving rotating speed precisely, identifying electrical/pole pass sidebands on 1×, separating sub-synchronous belt frequencies from oil whirl and rubbing. This lower frequency range constitutes Region 1.

Belt frequencies are generally in the 0.1-0.7× range, where X is the running speed. Rotor bars problems can cause vibration at 1×, 2× and 3× rpm with pole pass frequency (FP) sidebands, and pole pass frequency Fp is the slip frequency times the number of motor poles. Generally, around 1% frequency accuracy to resolve speed, 2% to resolve differences in belt and other sub-synchronous frequencies, and 5% to resolve electrical pole pass frequencies is needed.

For a 2-pole motor, 30 Hz speed, 3% slip (this is very typical), the minimum frequency resolution can be found to be 0.3 Hz for running speed, ˜0.3 Hz for belt frequencies, and 0.2 Hz for rotor bar sidebands. Maximum frequency range may be similarly calculated simply as 3× or three times the running speed or 90 Hz in this case. Therefore, in this particular example Region 1 may be defined as 0-90 Hz with 0.25 Hz resolution. The range may be different for different monitored machines though.

Region 2 is useful for resolving bearing frequencies and sidebands, evaluating high order running speed harmonics, gear mesh sidebands, vane pass frequency, unbalance, and misalignment. For these types of faults roughly 2% frequency accuracy is sufficient for bearing frequency resolution, and 5% to resolve sidebands. Bearing fundamental frequencies (BPFI, BPFO, BSF) typically range between 4-20× with sidebands at 1×. Common pinion gear tooth counts are 20-30 with 1× sidebands, and vanes in pumps range from 3× to 7× with 1× sidebands.

The minimum frequency resolution, considering fundamental bearing frequencies calls for a 2.4 Hz resolution and bearing frequency, gear mesh, and vane sidebands require a ˜1.5 Hz resolution. Considering pinion gears in gearboxes typically have around 20 teeth, various embodiments may be configured to monitor up to 25× and the highest rolling element frequency peak is around 20×. These frequency requirements result in a maximum frequency bandwidth for Region 2 of 750 Hz with a resolution of 2 Hz.

Region 3 is useful for resolving early bearing failure (bearing resonance), cavitation, looseness, and rotor bar frequencies. Roughly a 10-15% accuracy is sufficient for identifying loose rotor bars based on sidebands on a rotor bar fundamental frequency, for which are spaced at two times the line frequency. The line frequency in the US is 60 Hz and there are typically 35-96 rotor bars in induction motors. This results in a minimum frequency resolution of around 15 Hz. Bearing natural frequencies typically are in the 1500-6000 Hz range (50-100×) and cavitation in a similar range. These parameters point to Region 3 being bounded by 6 kHz, with a resolution of 15 Hz.

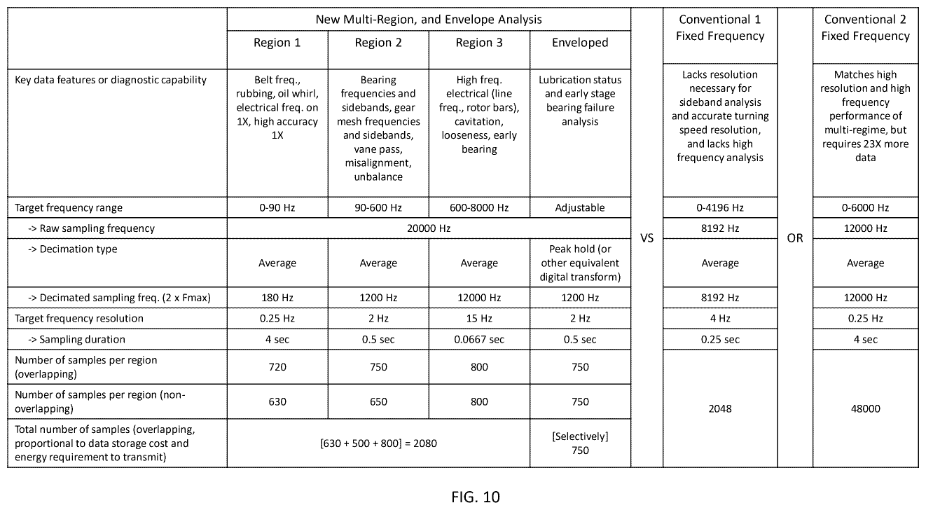

Considering the Nyquist frequency, the sampling frequency should be set at least 2× the highest frequency desired in the frequency spectrum. The resulting sampling for the three Regions is as follows: 12 kHz for 0.0667 seconds, 1200 Hz for 0.5 seconds, and 180 Hz for 4 seconds. An example of the specific data required to resolve these three regions is shown in FIG. 10. Two other conventional fixed and uniform sampling frequency scenarios are shown on the left side of the table as a comparison. As shown in FIG. 10, roughly a same number of data points are acquired between the “Conventional 1” sampling and the multi-region sampling. The multi-region technique has 16 times the resolution in the low frequency region, 2× the resolution in the middle region, and 50% higher frequency bandwidth than Conventional 1. Envelope analysis adds 36% more data and capability to measure lubrication status and more accurate early stage bearing failure monitoring. Conventional 2 sampling matches the frequency resolution of the multi-region sampling technique but requires 23 times more data. That increase in data volume can be thought of as reducing battery life by roughly 23× relative to the multi-region technique.

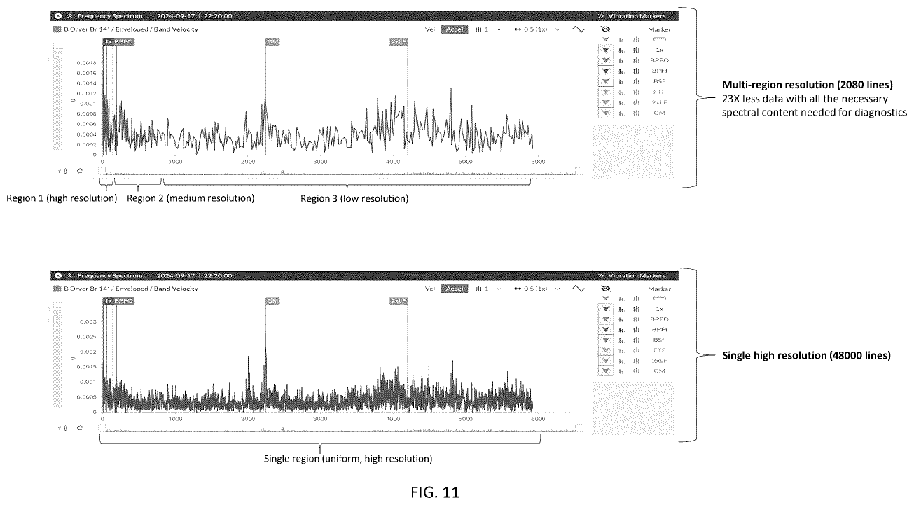

The upper plot in FIG. 11 shows vibration data acquired by the sensor node using multi-region sampling described in this invention. The lower plot is the same data set without the multi-region sampling. The sensor was mounted on large bearing in a paper mill. The fault frequencies that are used to diagnose the bearing fault are observed in both the multi-region data sets and single region data sets but the multi-region data set required 23× less data.

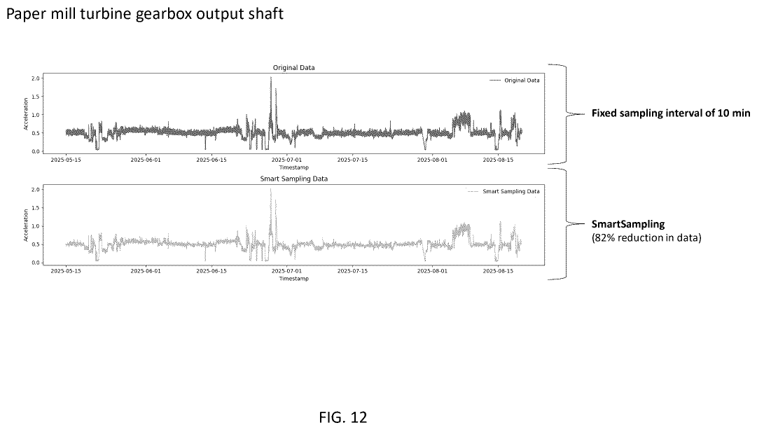

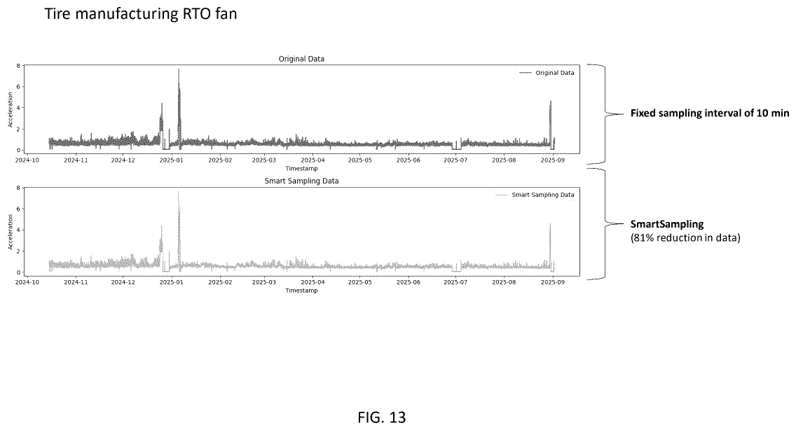

FIGS. 12 and 13 show the results of selective data block acquisition using the machine status monitoring and control program with a simple ON/OFF trigger threshold and interval setting threshold. The thresholds are trained in the cloud on historical data and applied withing a rule set specific to the machine at the node. The sensors are located on two different types of machines, a gearbox at the output of a turbine in a paper mill and an RTO fan in a tire manufacturing plant. Data reduction of 80% and 82% respectively were achieved without missing any of the important changes in vibration that corresponded to load variation, speed changes, faults, nor behaviors that prematurely wear machines. In accordance with various embodiments, any of the processing described herein may be performed at the sensor node or at the remote server.

This volume of data reduction relative to conventional sampling with fixed intervals and frequency spacing impacts sensor lifecycle cost (in terms of battery changes or battery cost) and performance which is essential to enabling the step change in ubiquity of online machine health monitoring to enable the field of predictive maintenance. These innovations constitute an important step forward in the field of machine health monitor and enabling greater operational efficiency for manufacturing plants.

Key points according to various embodiments may include the following:
1) Machine type, common fault modes, maintenance history, and historical vibration data is used to configure an machine status monitoring and data acquisition control program in the cloud.
2) The machine status monitoring and data acquisition control program may have thresholds and rules that are trained using machine learning or other AI based on historical data.
3) The machine status monitoring and data acquisition control program is wirelessly sent to the sensor node.
4) The sensor node executes the machine status monitoring and data acquisition control program.
5) The program uses a low power accelerometer to determine the status of the machine or machine based a simple set of rules like comparing the RMS vibration level to an ON/OFF threshold.
6) If the machine is determined to be in a state where machine faults could be expressed (ON) then high accurate data collections are initiated
7) The interval between collections is revised on an ongoing basis by the machine status monitoring and data acquisition control program, and in its simplest form can consist of one or more vibration threshold levels and acquisition intervals (spacing between data collections) that correspond to each level.
8) The vibration data collected in the high accuracy acquisition may include several different regions of data that have differing frequencies of vibration sampling (spacing between individual data points) and different durations of collection.
9) The multi-region sampling can be achieved by sampling initially at a fixed frequency and applying filtering to down sampling or decimating parts of the data to create single blended data set with several different regions.
10) The high accuracy data collection may also include several filtering steps including Envelope filtering a portion of the high accuracy vibration data.
11) A magnetic flux sensor and filter may be used in combination with the vibration data to determine machine speed considering motor slip.
12) An ultrasonic vibration sensor may sampled at very high frequency and filtered to produce several statistics that indicate machine health status.
13) The high accuracy vibration data, Enveloped data, speed data, and ultrasonic statistics are sent wirelessly to the cloud for machine health diagnostic processing.
14) The multi-region data may be processed using Fourier transforms in the cloud to produce either a single frequency spectrum with several different spectral resolutions that correspond to the differing sampling frequencies and durations.
15) Alternatively, the multi-region raw data can be separated into several separate frequency spectrum each corresponding to different regions.
16) A single composite time waveform data set may be generated by filling in lower resolution portions of the frequency spectrum and taking the inverse Fourier transform.
17) The high accuracy data in the cloud is then used to update the machine status monitoring and data acquisition control program which is then subsequently wirelessly sent back to sensor node to execute.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Aspects of the present invention are described herein with reference to flowchart illustrations and/or block diagrams of methods, apparatus (systems), and computer-readable storage devices having instructions stored therein for carrying out functions according to embodiments of the invention. It will be understood that each block of the flowchart illustrations and/or block diagrams, and combinations of blocks in the flowchart illustrations and/or block diagrams, can be implemented by computer readable program instructions. Each block in the flowchart or block diagrams may represent a module, segment, or portion of instructions, which comprises one or more executable instructions for implementing the specified logical function(s). In some alternative implementations, the functions noted in the blocks may occur out of the order noted in the Figs. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The computer readable program instructions also may be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). The software and/or algorithms described above and illustrated in the flowcharts may be modified in any manner that accomplishes the functions described herein. In addition, the functions in the flowcharts or description may be performed in any order that accomplishes a desired operation.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

1. A machine monitoring device for wirelessly monitoring a health condition of a machine, comprising:
a low power sensor configured to perform a machine status measurement of the machine at spaced intervals at a low power;
a high accuracy sensor configured to selectively perform high accuracy health status measurements of the machine;
a processor configured to analyze the machine status measurement from the low power sensor and to determine whether the machine status measurement is above a trigger threshold, and when the processor determines that the machine status measurement is above the trigger threshold, causing the high accuracy sensor to start the high accuracy health status measurements of the machine on an adjustable sampling interval, where a duration of the adjustable sampling interval is determined based on a level of the machine status measurement relative to one or more interval setting thresholds; and
a wireless transceiver configured to transmit data from the high accuracy health status measurements to a remote server for processing of the data for determining a health status of the machine.

2. The machine monitoring device of claim 1, further comprising a plurality of high accuracy sensors, wherein the processor is configured to set a plurality of adjustable sampling intervals for controlling each of the plurality of high accuracy sensors and where the adjustable sampling intervals are set based on one or a plurality of machine status measurements of the low power sensor relative to one or more interval setting thresholds.

3. The machine monitoring device of claim 1, wherein the processor is configured to receive and run a machine monitoring program configured to control the low power sensor and the high accuracy sensor.

4. The machine monitoring device of claim 1, wherein the low power sensor comprises a low power accelerometer.

5. The machine monitoring device of claim 1, wherein the high accuracy sensor is configured to perform at least one of vibration, ultrasonic vibration, magnetic flux, and temperature measurements of the machine.

6. The machine monitoring device of claim 1, wherein the microprocessor is configured to perform at least one of multi-region filtering, ultrasonic bandpass filtering and Enveloping of the data of the health status measurements of the machine before the data is sent by the wireless transceiver to the remote server.

7. The machine monitoring device of claim 1, wherein the processor is configured to dynamically update the trigger threshold and interval setting threshold based on past machine status measurements.

8. The machine monitoring device of claim 1, wherein the processor is configured to reduce the data from the high accuracy health status measurements to a multi-region time series before the data is sent to the remote server.

9. The machine monitoring device of claim 1, wherein the processor is configured to process data from the high accuracy measurement into a multi-region time series separated into one or more separate time waveforms with fixed time resolutions each having a separate frequency spectrum with a fixed frequency resolution.

10. The machine monitoring device of claim 9, wherein the processor is configured to process data from the high accuracy measurement into a multi-region composite frequency spectrum constructed by stacking together separate frequency spectrums of different resolutions and ranges, each corresponding to the separate time waveforms.

11. A method for wirelessly monitoring a health condition of a machine with a machine monitoring device having a low power sensor, a high accuracy sensor, a processor, and a wireless transceiver, comprising:
performing a machine status measurement of the machine with the low power sensor at spaced intervals at a low power;
selectively performing high accuracy health status measurements of the machine with the high accuracy sensor;
analyzing the machine status measurement from the low power sensor with the processor and determining whether the machine status measurement is above a trigger threshold, and when the status measurement is above the trigger threshold, causing the high accuracy sensor to start the high accuracy health status measurements of the machine on an adjustable sampling interval, where a duration of the adjustable sampling interval is determined based on a level of the machine status measurement relative to one or more interval setting thresholds; and
transmitting data from the high accuracy health status measurements to a remote server by the wireless transceiver for remote processing of the data for determining a health status of the machine.

12. The method of claim 11, wherein the machine monitoring device comprises a plurality of high accuracy sensors, wherein the processor is configured to set a plurality of adjustable sampling intervals for controlling each of the plurality of high accuracy sensors, and where the adjustable sampling intervals are set based on one or a plurality of machine status measurements of the low power sensor relative to one or more interval setting thresholds.

13. The method of claim 11, further comprising receiving from the wireless transceiver a machine monitoring program and running the machine monitoring program at the processor to control the low power sensor and the high accuracy sensor.

14. The method of claim 11, wherein the low power sensor comprises a low power accelerometer.

15. The method of claim 11, further comprising performing at least one of vibration, ultrasonic vibration, magnetic flux, and temperature measurements of the machine with the high accuracy sensor.

16. The method of claim 11, further comprising performing at least one of multi-region filtering, ultrasonic bandpass filtering and Enveloping of the data of the health status measurements of the machine by the processor before the data is sent by the wireless transceiver to the remote server.

17. The method of claim 11, further comprising dynamically updating the trigger threshold based on past machine status measurements.

18. The method of claim 11, further comprising reducing the data from the high accuracy health status measurements to a multi-region time series before the data is sent to the remote server.

19. The method of claim 11, further comprising processing data from the high accuracy measurement with the processor into a multi-region time series separated into one or more separate time waveforms with fixed time resolutions each having a separate frequency spectrum with a fixed frequency resolution.

20. The method of claim 19, further comprising processing data from the high accuracy measurement with the processor into a multi-region composite frequency spectrum constructed by stacking together separate frequency spectrums of different resolutions and ranges, each corresponding to the separate time waveforms.

21. A non-transitory computer-readable medium storing instructions which, when executed by a processor of a machine monitoring device, cause the system including a low power sensor, a high accuracy sensor and a wireless transceiver, to monitor a health condition of a machine by performing operations comprising:
performing a machine status measurement of the machine with the low power sensor at spaced intervals at a low power;
selectively performing high accuracy health status measurements of the machine with the high accuracy sensor;
analyzing the machine status measurement from the low power sensor with the processor and determining whether the machine status measurement is above a trigger threshold, and when the machine status measurement is above the trigger threshold, causing the high accuracy sensor to start the high accuracy health status measurements of the machine on an adjustable sampling interval, where a duration of the adjustable sampling interval is determined based on a level of the machine status measurement relative to one or more interval setting thresholds; and
transmitting data from the high accuracy health status measurements to a remote server by the wireless transceiver for remote processing of the data for determining a health status of the machine.

22. The non-transitory computer-readable medium of claim 21, wherein the machine monitoring device comprises a plurality of high accuracy sensors, wherein the processor is configured to set a plurality of adjustable sampling intervals for controlling each of the plurality of high accuracy sensors, and where the adjustable sampling intervals are set based on one or a plurality of machine status measurements of the low power sensor relative to one or more interval setting thresholds.

23. The non-transitory computer-readable medium of claim 21, wherein the operations further comprise receiving from the wireless transceiver a machine monitoring program and running the machine monitoring program at the processor to control the low power sensor and the high accuracy sensor.

24. The non-transitory computer-readable medium of claim 21, wherein the operations further comprise performing at least one of vibration, ultrasonic vibration, magnetic flux, and temperature measurements of the machine with the high accuracy sensor.

25. The non-transitory computer-readable medium of claim 21, wherein the operations further comprise performing at least one of multi-region filtering, ultrasonic bandpass filtering and Enveloping of the data of the health status measurements of the machine by the processor before the data is sent by the wireless transceiver to the remote server.

26. The non-transitory computer-readable medium of claim 21, wherein the operations further comprise dynamically updating the trigger threshold based on the machine status measurement.

27. The non-transitory computer-readable medium of claim 21, wherein the operations further comprise reducing the data from the high accuracy health status measurements to a multi-region time series before the data is sent to the remote server.

28. The non-transitory computer-readable medium of claim 21, wherein the operations further comprise processing data from the high accuracy measurement with the processor into a multi-region time series separated into one or more separate time waveforms with fixed time resolutions each having a separate frequency spectrum with a fixed frequency resolution.

29. The non-transitory computer-readable medium of claim 28, wherein the machine monitoring device comprises a plurality of high accuracy sensors, and wherein the operations further comprise setting a plurality of adjustable sampling intervals for controlling each of the plurality of high accuracy sensors, where the adjustable sampling intervals are set based on one or a plurality of machine status measurements of the low power sensor relative to one or more interval setting thresholds.
